(19) United States
(12) Patent Application Publication
(10) Pub. No.: US 2010/0186414 A1
(43) Pub. Date: Jul. 29, 2010

(54) MAGNETIC ION PLASMA ANNULAR INJECTION COMBUSTOR

(75) Inventor: Richard H. Lugg, Falmouth, ME (US)

Correspondence Address: BURNS & LEVINSON, LLP, 125 SUMMER STREET, BOSTON, MA, 02110, US

(73) Assignee: SONIC BLUE AEROSPACE, INC., Portland, ME (US)

(21) Appl. No.: 12/638,584

(22) Filed: Dec. 15, 2009

Related U.S. Application Data
(60) Provisional application No. 61/122,617, filed on Dec. 15, 2008.

(51) Int. Cl. F02C 7/22

(52) U.S. Cl. 60/740

(57) ABSTRACT

Discloses a technique for application of an external electric field to a mixture of atomized air, molecularized with fuel to a specific predetermined density, in an annular turbine combustor configuration. An electric current is distributed into the atomized air by a plurality of ion plasma fuel injector devices to affect the propagation speed, stability, flame size and shape and combustion chemistry of the fuel air mixture at the flame front.

### FIELD OF THE INVENTION

Present invention relates to combustion engines and to a technique for increasing combustion efficiency in the gas turbine engine.

### BACKGROUND OF THE INVENTION

Currently, the development of technologies for protecting the environment from hazardous emissions from engines is a priority in order to provide cleaner burning engines. Prior research has been conducted by applying electrical discharges to propagating flames forward of a gas turbine combustor. This prior work has shown that to enhance flame propagation velocity, promoting combustion in regions in a gas turbine engine upstream of the flame front in the combustor is desirable.

The flameholder of a burner for a conventional gas turbine engine includes a discrete area of recirculation in the combustor main body, typically made up of a series of apertures, or flameholders, having projections in the form of cusps formed on the upstream face. These projections face the combustion stream, to stabilize the flame front, and therefore combustion. This allows the improvement of the flameholder with a consequential reduction in the concentration level of gaseous pollutants. In this way it is possible to maintain a stationary flame within a high-velocity gas stream. The flame propagates through the combustible mixture at the flame speed, while the mixture is carried downstream. To have a stable flame the velocity of the gas mixture must be maintained within certain limits.

Over the past 50 years, high-performance gas turbine engine requirements have continued to push the state of the art in flame stabilization technology, namely flame holding technology. Because of these performance requirements the conditions which the combustor in a turbine is required to hold a flame at a given position, size, geometry and heat intensity has changed substantially and has become extremely technically challenging.

In recent years, the premixed lean mixture combustion environment has been adopted to reduce NOx emissions from the gas turbines. However, it can sometimes cause severe combustion instability, or hardware vibration. The leaner the mixture is to reduce the NOx, the more often it causes combustion instability which can reduce the life of the gas turbine components also. Furthermore, in order to improve thermal efficiency, the turbine inlet temperature is raised gradually and consequently NOx emissions from the gas turbines increase too.

Accordingly, a need exists for a stable combustion system in gas turbines for achieving higher thermal efficiency and reducing NOx emission from the gas turbines during operation thereof.

### SUMMARY OF THE INVENTION

In the disclosed technique, the fuel is treated prior to combustion to increase the efficiency and intensity of combustion. This pre-treatment is performed by imposing a magnetic field on the fuel as it is injected from an ion plasma injection port into a combustion chamber and by further imposing an electric field, which may be generated by onboard turbine generators.

According to one aspect of the invention, a combustor for use with the gas turbine engine comprises an array of combustion canisters, each canister comprising a plurality of elongate combustion tubes and a plurality of ion plasma fuel injectors fluidly communicating with the interior of the combustion tubes. In one embodiment, the fuel injectors comprise sources for creating both a magnetic field and an electric field in the proximity of the fuel injector tip where fuel is introduced into the interior of the combustion tubes. According to another embodiment, the control system for selectively providing power to the plurality of combustion canisters in a technique for selectively operating the same is also disclosed.

### BRIEF DESCRIPTION OF THE DRAWINGS

The above and further advantages of the invention may be better understood by referring to the following description in conjunction with the accompanying drawings in which:

FIG. 1 is a block diagram of an ion plasma combustor control system in accordance with one embodiment of the disclosure;

FIG. 2 is a front view of an ion plasma combustor array according to one embodiment of the disclosure;

FIG. 3 is a present perspective view of one of the plurality of combustor canisters from the array of FIG. 2;

FIG. 4 is a front view of the combustor of FIG. 3;

FIG. 5 is a side cut-away view of the combustor of FIG. 4 as taken along line A-A.;

FIG. 6 is a side cut-away view of the combustor of FIG. 4 as taken along line B-B;

FIG. 7A is a side cut-away view of single port fuel projector of FIG. 6;

FIG. 7B is a side cut-away view of dual port fuel projector of FIG. 6;

FIG. 8 is an exploded perspective view of one of the plurality of combustor canisters from the array of FIG. 2;

FIG. 9A is an exploded perspective view of the middle tube and hub assembly of the combustor canister of FIG. 8;

FIG. 9B is an exploded perspective view of an ignition tube the combustor canister of FIG. 8 relative to the hub assembly;

FIGS. 10A and 10B are front and perspective views of the middle tube separator of FIGS. 9A-B; and

FIGS. 11A and 11B are front and perspective views of the end tube separator hubs of FIGS. 9A-B.

### DETAILED DESCRIPTION

There exists three states of matter namely, solids, liquids and gases, in the order mentioned, one state of matter converts to another when energy is provided. If a gas is provided with sufficient additional energy, it transforms into “plasma” or an “ionized gas”, often referred to as the “fourth state of matter”. It is understood that a continuous source of energy is required to generate and sustain a state of matter. Man-made plasmas are commonly generated and sustained using electrical energy and are often referred to as “discharges”. In general, plasmas are realized by the generation of free electrons that make the gas conductive. These electrons obtain energy from the electric field and further ionize, excite and dissociate gas molecules via energy transfer during collisions. This makes plasmas very reactive. Also, plasmas possess higher temperatures and energy densities in comparison with most other chemical processes which make them interesting and efficient for various applications. They can be generated over a wide range of pressures and differ in electron temperatures and densities. Most applied plasmas have electron temperatures between 1-20 eV (1 eV≈1.6·10−19 Joule 11600 K) and densities between 106-108 (electrons/cm3). Considering the large size of a subsonic or supersonic combustion chamber, scaling up the thermal discharge for uniform plasma treatment in a magnetic field requires a lot of power.

Based in the nature of energy distribution, plasmas can be broadly classified into two kinds namely, 1) equilibrium or thermal plasmas and 2) non-equilibrium or non-thermal plasmas. Electrons gain energy from the electric field E, and lose this energy via collisions with neutral species. With an increase in pressure of operation p, the number of collisions increases. As the number of collisions increase, more energy is transferred from electrons to neutral species causing them to go closer to equilibrium. A parameter named reduced electric field E/p is considered here, which provides the idea about the average energy that an electron possesses in a plasma. The greater the value of E/p (higher E and/or lower p) the further apart is the average energy of the electrons from gas molecules. It has been reported in research on plasmas that this difference is proportional to the square of the ratio E/p. Thermal plasmas are ‘hot’, thus having high gas temperatures (usually >10,000K or 1340F). Due to equilibrium distribution of energy between electrons and gas molecules, the average electron temperature (Te)≈average gas temperature (Tg). Hence, thermal plasmas are characterized by low E/p values. These plasmas can usually be sustained at high power densities

Also, the number density (number per unit volume) of electrons (ne) is comparable to that of the gas (n), i.e. ionization degree, ne/n≧10−3. Lightning and thermal arc discharges are examples of both naturally occurring and artificially generated thermal plasmas, respectively. Auroras and low pressure glow discharges are examples of naturally occurring and artificially generated plasmas respectively. On the other hand, non-thermal plasmas are characterized by high E/p values. This implies that the average electron and gas temperatures significantly differ from each other, hence the title ‘non-equilibrium’ plasma. Here, electron temperature (T)>>gas temperature (T). The gas temperatures in non-thermal plasmas can vary from 300-3000 K. They operate at low power densities and but have very good chemical selectivity. Also, the ionization degree is usually n/n≦10−5 in these plasmas.

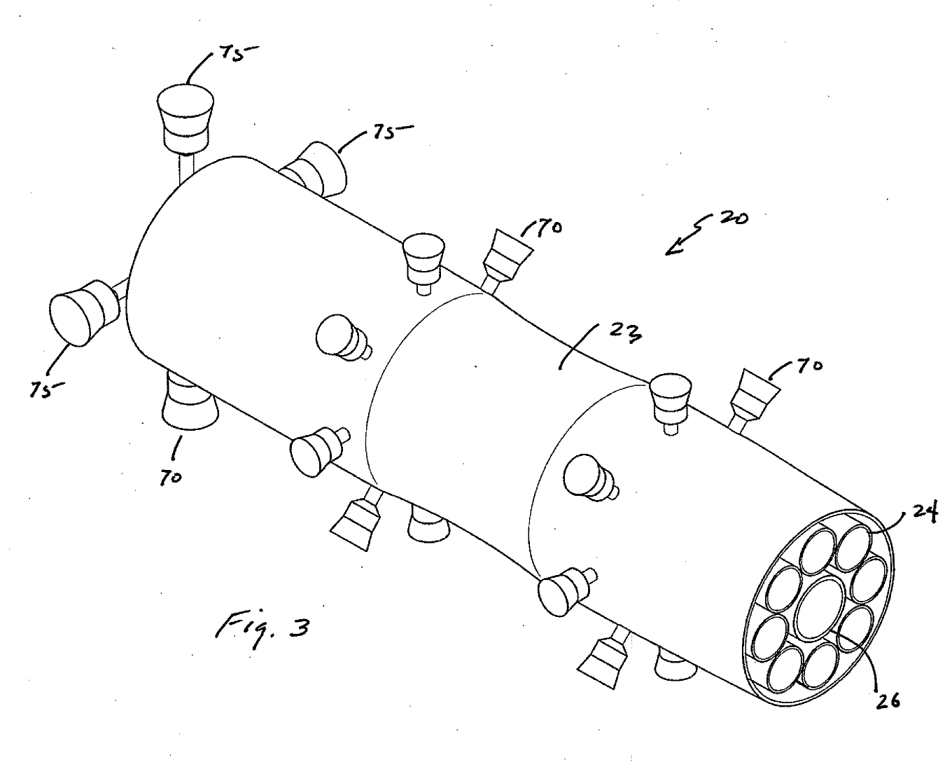

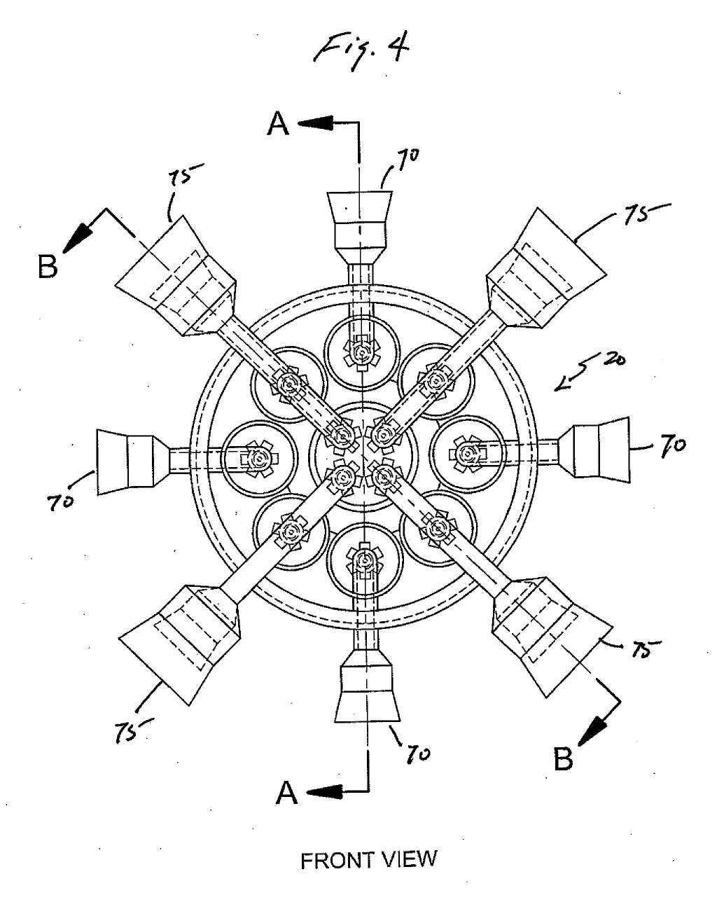

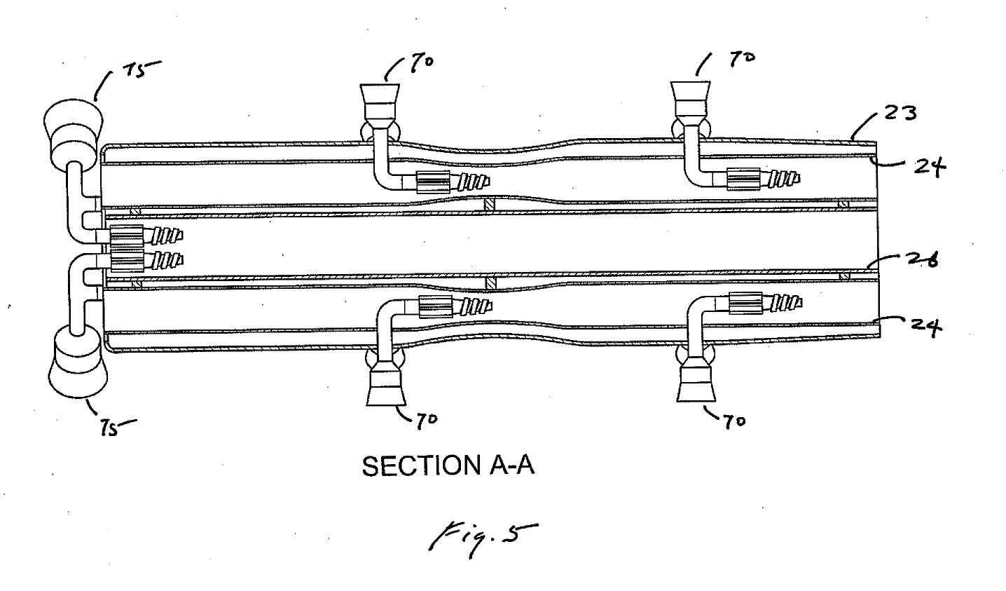

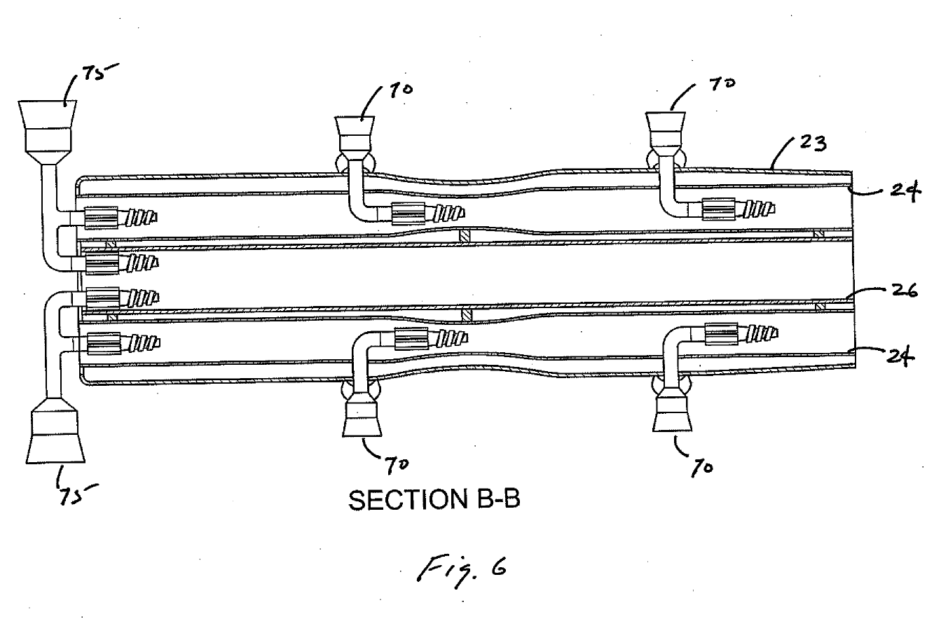

According to the disclosed technique, a plasma discharge is generated by applying a direct current (DC) electric field between two electrodes (for example, in gliding arc discharge). The magnetic ion magnetic plasma annular injection combustor (MIPAIC) receives power from DC electricity from the turbine ring generator behind the combustor in MAGJET, the hybrid turbine, with electric load directly deposited to the ion plasma injection electrodes. A power bus controls and maintains the electric load within specific limits to control the discharge and plasma intensity so as to maintain the average electron temperature (Te)≈average gas temperature (Tg), where gas temperature from combustion is roughly 2800 degrees F. Air exits in between the electrode pairs in a circular arc ring which follows the circumference of the interior of the combustor liner is illustrated in FIGS. 3-8.

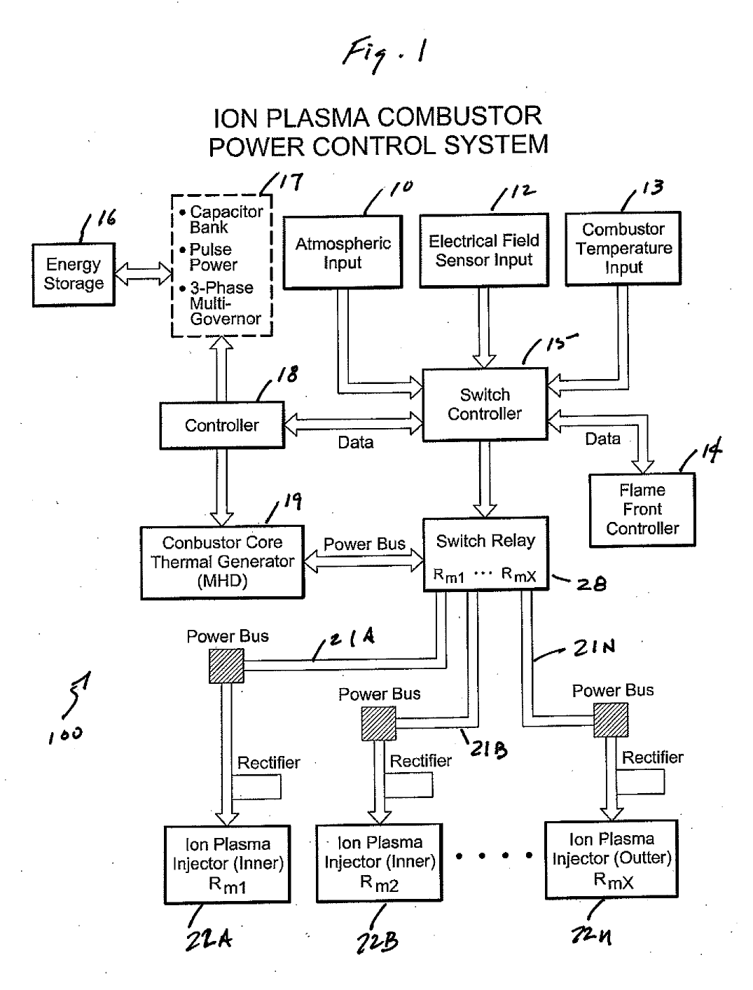

Referring now to one embodiment, FIG. 1 illustrates and ion plasma combustor power control system 100 comprising a plurality of sensors 10, 12, 13 and 14 coupled to a switch controller 15. An energy source 16 is coupled through any of a capacitor bank, pulse power or three-phase governor 17 to a controller 18 which is likewise coupled to switch controller 15 and a combustor core thermal generator 19 a switch relay 28 case with switch controller 15 which, in turn, through a series of power buses 21A-21n, provides electrical power to a respective ion plasma injector 22A-21n. Control 18 may be programmed to control switch controller 15 and switch relay 28 a manner to achieve the optimal performance as described herein.

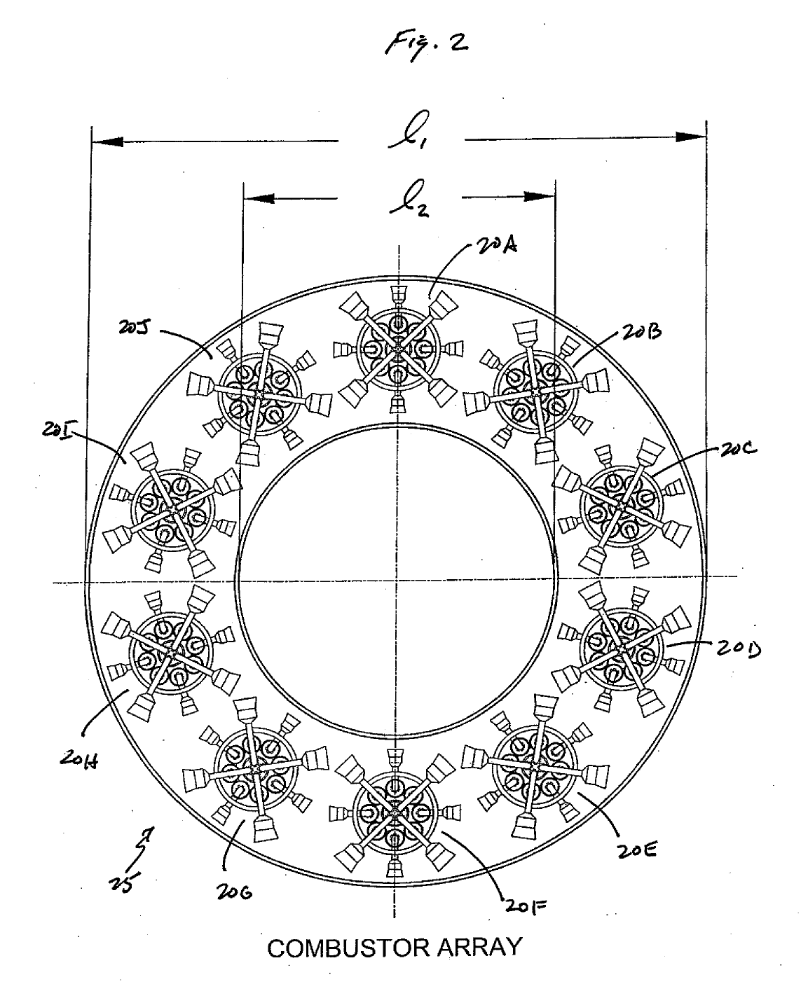

Is illustrated in FIG. 2, the annular combustor 25 in accordance with one embodiment is made up of numerous cylindrical annular combustor cans 20 A-J where each combustor can houses numerous ion plasma injectors 70 and 75, in a tandem array, with a higher number of injectors upstream to the source of compressed incoming air from the diffuser and compressors, than the number of injectors further downstream to the airflow, is illustrated in FIGS. 3-6. The injector body's are opposed to one another at, ninety, one hundred and eighty, two hundred and seventy and three hundred and sixty degrees within the annular can, other configurations can also be used. Positioning is set so that at the upstream end of the combustor can the injectors are more closely spaced together when compared to the downstream end of the annular combustor can is illustrated in FIG. 3, where they are typically spaced further apart. The placement of the ion plasma fuel injectors within each of combustor can 20A-J is set so as to provide a high degree of atmospheric saturation of the fuel and the magnetic field enhances the highest parts per million count of fuel to the density ratio of the incoming air (oxidizer) as determined by the pressure differential from the upstream compressor and the diffuser air, and the temperature gradient across the can, from the downstream lower pressure and diffused air. This is done so that the mass of compressed heated air, as its velocity is slowed by the last several diffuser vane stages in front of the combustor, and the cylindrical arrangement of annular combustors cans, the higher velocity compressed air interacts with the higher density molecularized fuel that is dispersed as it is coming from the higher density arrangement of the electrically charged ion plasma injectors per square area at the interior perimeter first of the annular combustor cans, compared to the lower density of placement per square area of the ion fuel injectors at the back of the can annulus (closed end).

For the magnetic ion plasma combustion process to begin, heated air flow from the compressor impinges on the closed end of the annular combustor cans 20 A-J which sit in a circumferential array around the interior of the combustor liner, as illustrated in FIG. 2. The diameter of the combustor liner L1 closely matches the diameter of the last compressor stage and may be roughly 36″. The circumferential array of the annual combustor cans 20A-J which make up the predominant mixing area between the molecularized fuel and the compressor inlet air inflow is slightly smaller in diameter, where each annular burner can is roughly 10.0″ in diameter, with a diameter L2 of roughly 6.0″ in the center where to the exterior of the inner combustor liner, bypass air from the bypass fan forward or the combustor and compressor stages, provides additional propulsive thrust and cools the interior of the combustor. The annular combustor cans 20 A-J are structurally supported by the interior and exterior combustor liners and at there circumference of the end plate for the combustor chamber. Each annular combustor can has a large hole at the closed end of the can with a stream tube, which has several slots in it to let heated compressed air into the interior of the can where the ion plasma injector arrays are stationed.

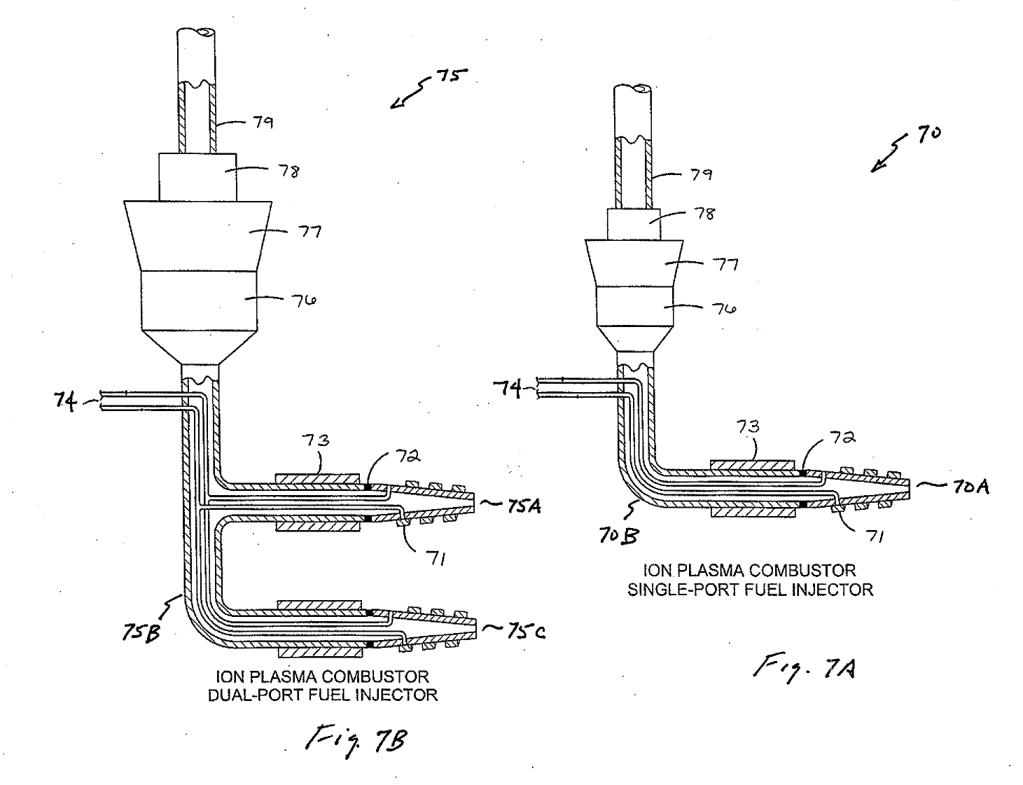

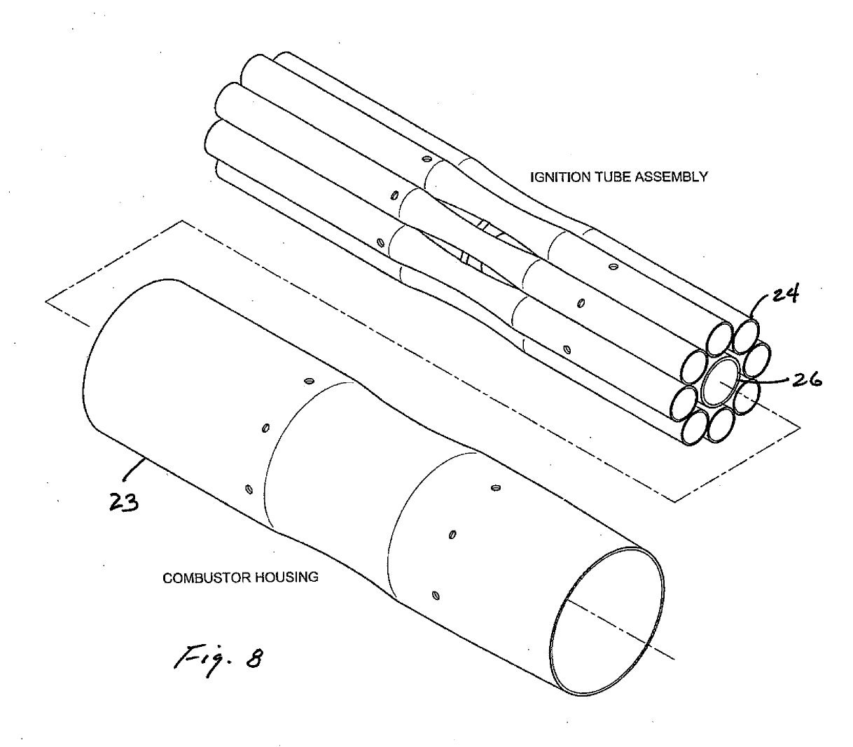

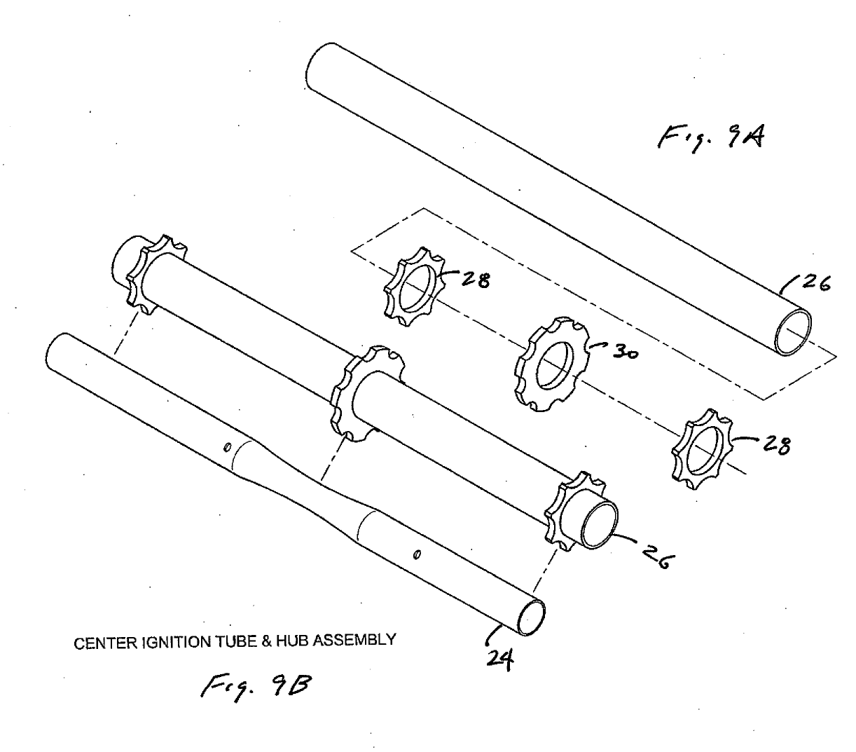

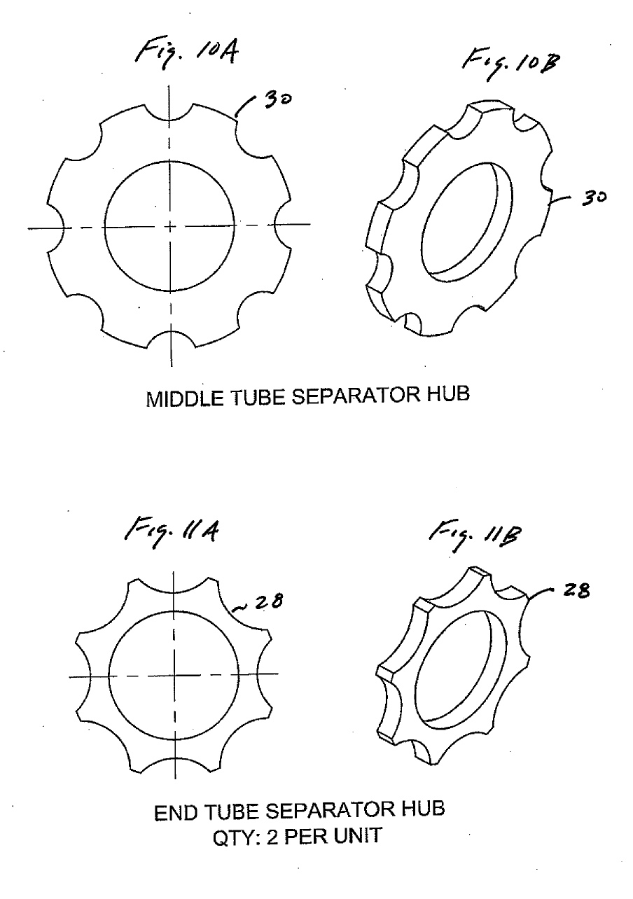

Is illustrated in FIGS. 3-9, each canister 20A-J may comprise any canister housing 23 in which an ignition assembly comprising a plurality of elongate combustion chamber tubes 24 are annually disposed around a central combustion chamber tube 26. Tubes 24 are separated from 26 by separator hubs 28 and 30, as illustrated. Tubes 24 include a plurality of apertures disposed around their perimeter into which injectors 70 are disposed.

According to one aspect of the disclosed embodiments the flameholder, and/or a flameholder region within the combustor 25. In one embodiment, the geometry of the cylindrical annular combustor 25 is designed for combustion efficiency and includes a novel radial magnetic soaring arc flame stabilizer (RMSAFS) to stabilize the flame front and its progression across the combustor. No physical cavities or apertures are utilized to stabilize the frame front during circulation as I used in the prior art. This configuration also addresses combustion noise, reducing it as the flame front is protected from temperature surges and instabilities which the magnetic arc field controls, which is the driver for acoustic stability and can be suppressed to as low levels as 80 dB while the NOx emission can be kept in the single digit level (6.0-9.0 PPM) with 1300.0 degree C. combustor exit temperature at atmospheric condition.

A plasma discharge system should generate non-equilibrium plasma with high concentration of active species and intermediate, and in some cases adjustable, temperature, high enough to support chain continuation reaction. The plasma discharge that is utilized in the RMSAFS is a soaring arc (SA) plasma discharge. This unique discharge has relatively high plasma density (1012−10, 14 cm−3), power and operating pressure in comparison with other non-equilibrium discharges; a high electron temperature (>1 eV) and relatively low gas temperature (<3000K) and good chemical selectivity in comparison with thermal discharges.

Typically Soaring Arc (SA) plasma discharges are very unstable for combustion applications. The disclosed system 10 is driven and stabilized by a radial magnetic field encircling the combustor interior, aft of the plasma injectors 70 and 75, but upstream of the exhaust manifold. The magnetic Soaring Arc is a non-equilibrium plasma arc that can be coupled with a counter flow burner for ignition and combustion.

The disclosed ion plasma combustor includes two types of plasma fuel injectors, a single port injector 70 and a dual port injector 75. The function of the injectors is to carry fuel to the combustor under pressure and form the fuel into a plasma fuel as it enters the combustor chamber 24 or 26 with an ionic charge, thus creating the plasma. The dual and single port plasma fuel injectors are so arranged that they alternate around an eight chamber annular combustor design is illustrated in FIGS. 3-8. The injectors are positioned so that they maintain and control the position of the flame front in and electromagnetic field that they produce as the fuel combusts and maintain velocity flow of the plasma and entering air pressure from the upstream electric compressor. Starting from the tip 70A, the plasma coil generator 71 provides high power electricity coming from the DC 3-Phase charge/ground connections 74 that feed into the back of the injector body 706. This creates the electric charge from the tip and ionizes the fuel as it injects into the combustor chamber 24 or 26. A permanent magnet 73 controls the plasma fuel by attracting the ionized fuel and is so arranged so as to create a specific magnetic field so as to form a progressing “electric fan field” that paces down the combustor from one injector set to the next. The magnetic field controls the combustion process and stabilizes it allowing for complete combustion of the atomized ionized fuel. Above the fuel injector body is the fuel charge reservoir 76 which instills a +charge, or −charge on the fuel before it enters the injector. Reservoir 76 acts as an electronic filter, the plasma coil generator 71 increases the charge to the fuel just before it enters the combustor with current at 200 amps and 70 volts, for example. The fuel filter chamber 77 and fuel pump 70 any above it ensure there is a final filtration process on the fuel before it enters the combustor chamber. The fuel pump 70 creates the pressure for the injector to reduce the molecule structure of the fuel to a point of atomization under pressure before it enters the combustor. Additionally there is conductive heating of the fuel in the injector which is novel as the body of the injector is heated by the plasma generation coils, further assisting the combustion process. Dual port ion plasma fuel injector 75 is similar in design and function to injector 70, described above, except that the injector body 75B has 2 tips 75 8 and 75 seat extending their from similar in design function two tips 70A Of injector 70.

The electric field and the magnetic field affect the ion charge of the fuel air stream from the point of discharge at the ion plasma injector. The magnetic field component may be made from a permanent magnet of a rare earth composition, for example, Neodymium-iron-boron (NdFeB), or Samarium-cobalt, Al-nico electromagnets. The permanent magnets are moldable and attached to the exterior stainless steel bodies of the ion plasma fuel injectors and create the out-of plane (normal) magnetic field which is in line with the axial length of the injector body. The electric current is developed through a series of small copper coils which are disposed on the exterior of the injector down the length of each ion plasma injector and are responsible for an axial field component which is tangential to the out-of-plane (normal) magnetic field component.

The pre-combustion treatment of the fuel fluid stream by the magnetic and electric fields, decreases molecular agglomeration of the fuel by reducing effects of Van DerWaals forces, increases the electric charge density and electric current density of the fuel, and decreases fluid density. Fluid density is an important parameter of magnetohydrodynamics as a small change in density can result in a large change in particle acceleration. These conditions create an equivalent temperature increase in the fuel. A non-thermal plasma treatment is thereby achieved by application of, and modifying the ionic field of the fuel, with the normal plane magnetic field component and the axial electric field component, creating ions, electrons, charge neutral molecules and other species in varying degrees of excitation in the fuel stream with a subsequent change in temperature of the fuel, in effect superheating the fuel just prior to combustion.

In this manner, the ion plasma fuel injection design provides the fuel prior for combustion with a modified molecular makeup, i.e., in a plasma state, due to the high strength magnetic and electric fields that flow down the axial length of the injector tube. The high field strength treatment is obtained by subjecting the fuel within each of the multiple spray bars within the injector stream tube thereby creating a thin film of fuel aligned to the in-plane electric field and tangential (out-of plane, normal field) magnetic fields. The electric and magnetic field components form a fluted wall within the fuel injector body as the fuel exits into the combustor cans past the spray bars, therefore creating small annular spaces through which a thin flowing film of fuel grows and is forced to flow in a highly heated and atomized state into the annular combustor cans.

This in essence is a “fuel plasma”, not combusted, but very close to it in a superheated state. The “fuel plasma” once formed, molecularly moves at a particular rate of velocity down the length of the annular combustor cans, expanding under the pressure from the compressor air entering at the top of the can 24 through the stream tube. Not all the air from the compressor enters all the annular combustor cans 24 in circular series around the circumference of the interior of the combustor. The combustor 25 is so designed to allow for a percentage of compressed inlet air to bypass the array of individual combustor cans, by passing through an axial gap between the inner combustor liner and the outer circumferences of the annular combustor cans. This heated air moving at high velocity, in some conditions close to Mach 0.7 (650 ft./sec.), is slowed as it enters the main combustor 25 by a series of diffusers which expands the air, lowers pressure, and slows the velocity. As it passes the annular combustor cans, the portion of the compressed air which entered the open ends of the annular combustor cans through the stream tubes, and having been molecularized by the ion plasma injectors, now mixed and swirled with air as a “fuel plasma” is forced to exit via the spray bars or apertures along the lengths of the annular combustor cans, and as such, it enters the central free stream of the compressed air coming from the compressor and upstream diffusers, regulating immediate combustion at the back of the combustor, and in front of a magnetic flame holder, which are designed to hold the flame, or combustion front, thus maximizing mixing and combustion, therefore maximizing the reduction of the NOX and CO2 content.

The configuration of the ion plasma injector is a tube-like geometry with an array of distributed holes from which pressurized fuel is sprayed into the heated air stream coming from the compressor and further in advance of the flame front. The flame front is generated by an igniter ring, which is a series of igniters disposed on a circular feed fuel tube which surround the exterior of the annular combustor with the igniters pointing inward toward the interior of the annular combustor cans through orifices and are sealed by high temperature nicolon fiber wound seals. The dimensions of the array of the holes down the length of the tube injectors may be several inches with the tube diameter being, in one embodiment, a half inch in diameter approximately. Each hole has a spray bar arrangement to disperse the fuel from each hole under high pressure, the spray bar being a plate that disperses the fuel molecules into smaller molecules. Below where the fuel spray holes in the spray bar are the ion plasma injector tubes that are solid with no holes in the circumferential tube surface, but still hollow in its center. Each ion plasma injector is cylindrical in shape and includes two semi-circular segments of electric and magnetic field components. The injector tubes are concentric cylinders of alternating electric and magnetic field components, which generate counter rotating magnetic and electric flux fields, one of which is in-plane to the ion plasma injector and one of which is normal to the ion plasma injector. The in-plane field is generated by a high power electrical current, which in one embodiment is 480 amps and 2150 volts. Other voltages and currents may be used depending on the needs of the engine.

This electric current may be cable wired via leads 74 from system 100 to the surface of each ion plasma fuel injector 70 or 75, with electrical filtering and buses selectively placed to maintain the amperage and current to all the ion plasma injectors on the exterior of the combustor and highly insulated. This electrical management equipment is also cooled by exterior bypass air generated by bypass fans in the front of the engine that is also used to cool the combustor liner.

In one embodiment of the ion-plasma fuel injector 70 or 75, the electric field and magnetic field flux components are provided by external magnets and coils as discussed above. In another embodiment, the nozzle section of the injector is made of a magnetic material onto which an electric coil is disposed. The magnetic field affects the injected fuel stream as discussed above and the electric field molecularizes it, and heats it, and moves it into the circular array of annular combustor cans. Each ion plasma injector tube 24 with multiple spray bar holes is the source of the magnetic field vector when made from the magnetic material, and simultaneously, contains an electric, axial field component as supplied by a nozzle discharge section electrified by the power source from superconducting ring generators, transmitted conductively with an electric field material (copper aluminum oxide) and inserted within the magnetic portion of the injector nozzle. In this configuration, both the electric and magnetic fields are supplied to the fuel and air mixture immediately before and during combustion. In yet another design approach, electric field and magnetic field components could be inserted into the exterior of the annular combustor can, with the two field components projecting into the annular can combustor. This forms clouds of fuel around each injector port and the combined effect of the plurality of fuel clouds is to form a controlled flame front when ignited. In this way, the flame fronts are controlled and maintained such that fuel is burned through nearly the entire length of the combustion can resulting in a more complete fuel ignition.

The electric-arc generated from the turbine ring generator(s) behind the combustor, deliver pulsed phased millisecond plasma discharge voltages to the atomized fuel stream prior to combustion, to produce an ionized fuel. The plasma enhancement through the use of the plasma-generating electrode fuel nozzle, with electric and magnetic fields, modifies combustion, flame structure, flame size, and flame power density extending the fuel-lean burn limits and therefore increasing caloric fuel burn efficiency. This provides the ability of burning low caloric based fuels very efficiently such as bio-based ethanol fuels and biodiesel fuels

The plasma discharge being an AC current must be inverted through a power inverter integrated as part of the engine system of which the ion plasma combustor is also a part of. The alternating current electrical signal will typically have a frequency on the order of 1000 Hertz and the duty cycle has a rate on the order of 200 times per second. The duty cycle of the engine of which the ion-plasma combustor is a systems component of operates at 350 Hertz and will incorporate a transformer and power bus to bring the duty cycle to 1000 Hertz to operate the ion plasma combustor. Other frequency and duty cycles may be used depending on the system requirements.

The ion plasma injection combustor, by superheating pre-combusted fuel will also raise the nitrogen oxide content. To meet new Federal and European aviation emissions regulation by the International Commercial Aviation Organization (ICAO) in 2015, almost all nitrogen oxide must be removed from the exhaust effluent through the exhaust nozzle.

The removal of nitrogen oxide from the combustion processes and the subsequent exhaust plume is therefore very important. This is accomplished by utilizing a series of parallel plates of a thick insulating medium (e.g., aluminum oxide substrate) which acts as a dielectric barrier, wherein the ion plasma injectors are arranged so to be parallel to the exhaust flow though the annular combustor cans, and the plasma injection includes at least one premixed combustor fuel and air injection port having a plurality of dispersing spray bars (apertures) and the combustor fuel and air is spread evenly throughout the annular combustor can to reduce concentrations of fuel and thus obtain a more evenly distributed combustion, and that these plasma ion injectors are positioned accordingly on opposite sides of the insulating dielectric material. Here through which, along the sides of the annular combustor, so as to maximize the flow of the preheated (or superheated fuel from the plasma arc emitted from the plasma ion injectors) fuel are therefore arranged slots or holes which allow for the passing of the combustion gasses into the central combustor from the individual circular array of annular can combustors.

It is known that both removal efficiencies of NO are enhanced with increasing applied voltage and/or gas temperature. According to another aspect of the disclosed the ion plasma injector turbine combustor is that the voltage at the dispersing area of the electric field at/or near the tip of the ion plasma injector can be increased or decreased to increase NOx removal of the preheated gas stream (from compression) and the superheated fuel as it approaches the combustion point.

Another component of the invention regarding NOx reduction is that water vapor is extracted from the atmospheric bypass air that flows around the combustor and is added to the gas stream to reduce NOx as well. This is done by the bypass air openings on the interior casing of the inside bypass air duct surrounding the interior of the main combustor housing which is created by a shaftless exoskeleton design in the combustor. The bypass air is purged into the interior of the combustor upstream of the annular combustor cans (on the interior of the main combustor housing) but downstream from the last row of the diffusers prior to air entering the main combustion chamber and flame front and magnetic flame holder mechanisms.

Here the water is boiled off from the air as steam and added to the incoming pressurized air from the compressor. This lowers the temperature slightly but has the benefit of added water vapor to the combustion gas stream which reduces NOx in the combustion process from the time the fuel is superheated and molecularized at the ion plasma injectors and becomes part of the “fuel plasma” to the point it becomes completely atomized past the injectors but just ahead of the igniters and flame front as a completely swirled and atomized expanding, pre-combusting gas front. Chemically the additional water vapor in the gas stream affects the NOx removal process by generating OH radicals to convert to NO₂ to form HNO₃, a much lesser toxic gas effluent in the final exhaust plume from the combustor and one that is not controlled by emissions requirements.

As much as 100% of NO and 57% of NOₓ can be removed at temperatures as low as 140° C. for gas streams containing [NO]:[C₂H₄]:[H₂O_{(g)}]:[O₂]:[N₂], which is typical chemical and stochiometric content from a gas turbine generator, and higher amounts of NOₓ are removed as the combustion temperature rises. In the invention the combustor 25 is designed to operate at a minimum of 670° C., with complete removal of NOₓ from the combustor exhaust efflux starting at 1225° C.

It is to be understood that the above-described embodiments are merely illustrative of some of the many specific embodiments that represent applications of the principles discussed above. Clearly, numerous and other arrangements can be readily devised by those skilled in the art without departing from the scope of the invention.

What is claimed is:

1. A combustor for use with the gas turbine engine comprising:
an array of combustion canisters, each canister comprising:
a plurality of elongate combustion tubes, and
a plurality of ion plasma fuel injectors fluidly communicating with the interior of the combustion tubes;
the fuel injectors further comprising:
a tip disposed within an interior portion of one of the combustion tubes,
a magnetic field source disposed proximate of the injector tip, and
an electric field source disposed proximate of the injector tip.
